(19) United States
(12) Patent Application Publication
(10) Pub. No.: US 2011/0246760 A1
(43) Pub. Date: Oct. 6, 2011

(54) ELECTRONIC DEVICE AND ELECTRONIC DEVICE SYSTEM

(76) Inventor: Seiji UETA, Yokohama-shi (JP)

(21) Appl. No.: 13/158,107

(22) Filed: Jun. 10, 2011

Related U.S. Application Data
(63) Continuation of application No. PCT/JP2009/071071, filed on Dec. 11, 2009.

(30) Foreign Application Priority Data
Dec. 11, 2008 (JP) 2008-316063

(51) Int. Cl. G06F 15/177

(52) U.S. Cl. 713/2

(57) ABSTRACT

According to one embodiment, an electronic device system includes a first controller and an electronic device. The first controller includes a command terminal for outputting a command to an electronic device and a plurality of data terminals for transmitting/receiving data. The electronic device coupled to the first controller via the command terminal and the data terminals, the electronic device stores a boot information, wherein when power is turned on, the first controller generates a signal and supplies the signal from one of the data terminals to the electronic device, and receives the boot information read from the electronic device in accordance with the signal.

### CROSS-REFERENCE TO RELATED APPLICATIONS

This is a Continuation Application of PCT Application No. PCT/JP2009/071071, filed Dec. 11, 2009, which was published under PCT Article 21(2) in Japanese.

This application is based upon and claims the benefit of priority from Japanese Patent Application No. 2008-316063, filed Dec. 11, 2008; the entire contents of which are incorporated herein by reference.

### FIELD

Embodiments described herein relate generally to an electronic device using, for example, a flash memory, and to an electronic device system in which the electronic device is embedded.

### BACKGROUND

Memory systems, for example, memory cards using nonvolatile semiconductor memories such as flash memories, have been used as recording media of music data and video data. As the flash memory used in the memory system, there is known a NAND flash memory, for example. In addition, as the memory system, there is known an SD™ card, for example (see, e.g. Jpn. Pat. Appln. KOKAI Publication No. 2006-92019).

The memory system is connected to a host apparatus, and data is transmitted/received between the memory system and the host apparatus. An SD interface is known as an interface between the memory system and the host apparatus. The SD interface is an interface with the host apparatus which supports an SD device such as an SD™ card.

In an SD interface bus, a plurality of signal lines, for example, a clock line, a command line and a data line, are defined. These lines are treated as a single bus.

In recent years, host apparatuses, which use a flash memory as a nonvolatile memory device, without having a hard disk drive, have been manufactured. Such a host apparatus needs to read from the flash memory a program code (boot code) which is necessary for booting up the system. Specifically, the boot code is stored in the SD device which is composed of a flash memory, and the boot code is transferred to the system memory via the host controller and is executed.

The boot code is first read after the host apparatus is powered on. Specifically, when the system is powered on, a boot loader, which is stored in a system ROM, is activated by the CPU. The host controller is configured to read the boot code, which is stored in the SD device, according to the boot loader, and to transfer the boot code to the system memory. Thus, the system requires the system ROM for storing the boot loader, and this leads to an increase in manufacturing cost for the system. Therefore, there has been a demand for an electronic device system which requires no system ROM.

### BRIEF DESCRIPTION OF THE DRAWINGS

FIG. 1 schematically shows the structure of a host apparatus and an electronic device according to an embodiment of the invention;

FIG. 2 schematically shows a memory map of the electronic device;

FIG. 3 is a timing chart showing an example of a quick boot operation according to the embodiment;

FIG. 4 is a flow chart illustrating an access operation of a boot code area; and

FIG. 5 shows an example of application of the embodiment.

### DETAILED DESCRIPTION

In general, according to one embodiment, an electronic device system includes a first controller and an electronic device. The first controller includes a command terminal for outputting a command to an electronic device and a plurality of data terminals for transmitting/receiving data. The electronic device coupled to the first controller via the command terminal and the data terminals, the electronic device stores a boot information, wherein when power is turned on, the first controller generates a signal and supplies the signal from one of the data terminals to the electronic device, and receives the boot information read from the electronic device in accordance with the signal.

An embodiment of the present invention will now be described with reference to the accompanying drawings.

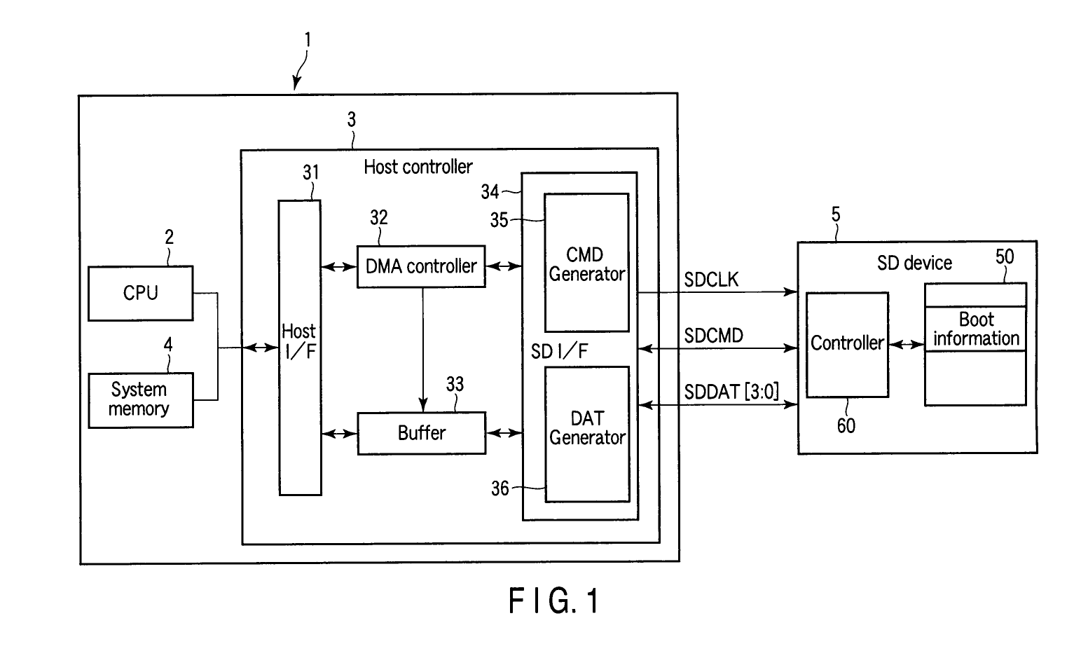

FIG. 1 schematically shows the structure of a device according to a first embodiment of the invention, and the structure of a host apparatus in which this device is embedded.

The host apparatus 1 includes, for example, a central processing unit (CPU) 2 functional as a processor, a host controller 3 and a system memory 4.

The CPU 2 executes overall control of the host apparatus 1, and operates according to a program, etc. stored in a read-only memory (ROM) (not shown). The system memory 4 is used for storing an executable program, which is necessary for the operation of the CPU 2, and various data.

The host controller 3 includes, for example, a host interface (I/F) 31, a dynamic memory access (DMA) controller 32, a buffer 33 and an SD interface 34. The host I/F 31 is connected to the CPU 2 and system memory 4, and is also connected to the DMA controller 32 and buffer 33. The buffer 33 is connected to the SD I/F 34.

The host controller 3 is configured to be communicable with, for example, an SD device 5 which is composed of, e.g. a flash memory. Specifically, the host I/F 31 is configured to be communicable with the CPU 2 and system memory 4, and the SD I/F 34 is configured to be communicable with the SD device 5.

In addition, the host I/F 31 transfers data, which is delivered from the system memory 4, to the buffer 33, and transfers data, which is read out of the SD device 5 and is held in the buffer 33 via the SD I/F 34, to the system memory 4.

The SD I/F 34 transfers data, which is delivered from the system memory 4 via the buffer 33, to the SD device 5, and receives data, which is read from the SD device 5, and delivers the received data to the buffer 33.

For example, according to instructions of the CPU 2, the DMA controller 32 controls the host I/F 31, SD I/F 34 and buffer 33, and controls data transfer from the system memory 4 to the SD device 5 and data transfer from the SD device 5 to the system memory 4.

The SD I/F 34 is connected to the SD device 5, for example, via a 1-bit clock line, a command line, and a 4-bit data line. At the time of signal reception, the SD I/F 34 takes in a command SDCMD on the command line and data SDDAT on the data line, the rising edge of a clock signal SDCLK on the clock line. At the time of signal transmission, the SD I/F 34 outputs a command SDCMD, a response and data SDDAT to the command line and data line, on the rising edge or falling edge of the clock signal SDCLK on the clock line. The data line can transfer data in parallel with four bits, or in series with one bit.

Specifically, the SD I/F 34 includes a command (CMD) generator 35 and a data (DAT) generator 36. The CMD generator 35 generates, for example, according to an instruction of the CPU 2, various commands for controlling the SD device 5, and delivers the commands to the SD device 5. The DAT generator 36 generates a signal according to an instruction of the CPU 2, and outputs the signal to the data line SDDAT [3:0].

The SD device 5 comprises, for example, a NAND flash memory 50, a controller 60 for controlling the operation of the flash memory 50, and a clock terminal, a command terminal and data terminal which are connected to the clock line, command line and 4-bit data line of the SD I/F 34.

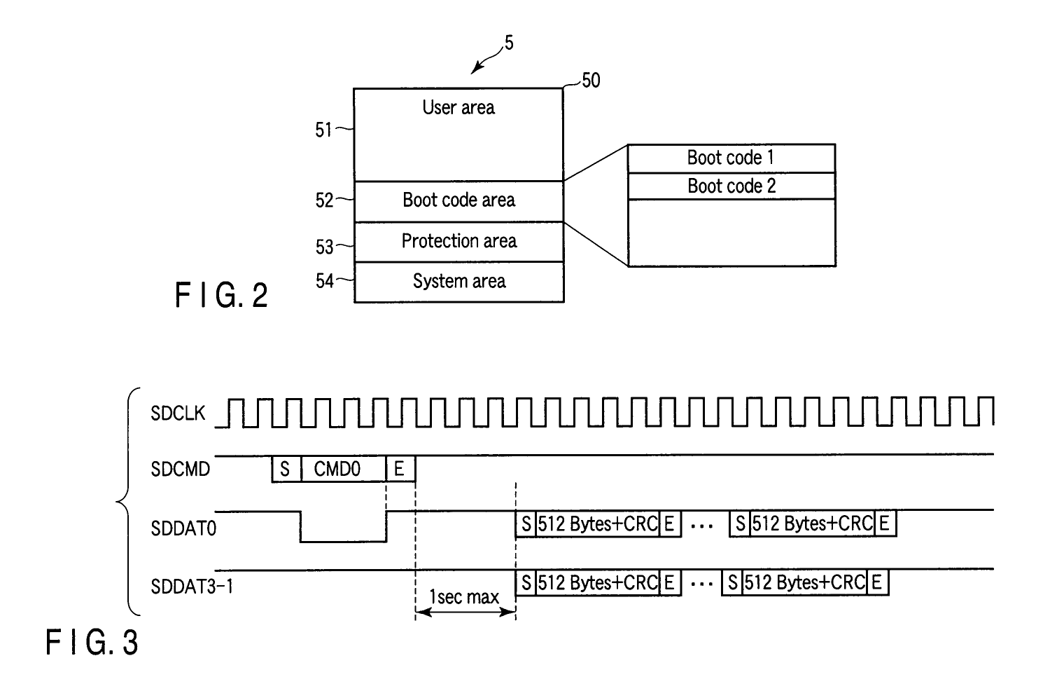

FIG. 2 shows an example of the memory map of the SD device 5. The NAND flash memory 50 comprises a user area 51, a boot code area 52, a protection area 53 and a system area 54.

The user area 51 is an area which can freely be accessed and used by the host apparatus 1 and the user of the host apparatus 1. The user area 51 stores arbitrary data such as various data and a program necessary for the operation of the host apparatus. The data in the user area 51 is managed, for example, by a file allocation table (FAT).

The protection area 53 stores, for example, data which is accessible by only the specified host apparatus 1. The user of the host apparatus 1 can access the protection area 53, only in the case where a predetermined condition is satisfied.

The system area 54 is an area which cannot directly be accessed by the host apparatus 1 and the user. The system area 54 is the area that is managed by a controller (not shown) in the SD device. For example, the system area 54 stores control information of the controller, and security information.

The boot code area 52 stores, for example, a boot code 1 and a boot code 2. Each of the boot code 1 and boot code 2 is a set of codes for executing at least a part of the series of processes which need to be executed after the power-on of the host apparatus 1 and before the start of the system (OS). The boot code 1 and boot code 2 are identical. For example, in the case where a defect has occurred in the boot code 1, the boot code 2 is used.

The data in the boot code area 52 is not managed by the file system. In the boot code area 52, for example, boot codes are stored in the order from a page of a lower address toward a page of an upper address. After power-on, the controller 60 successively reads the boot code 1 in the boot code area 52 in the order from a lower address toward an upper address, in accordance with a quick boot request (to be described later) which is delivered from the host controller 3, and transfers the boot code 1 to the host controller 3.

### (Quick Boot Operation)

Next, the quick boot operation according to the present embodiment is described.

If the host apparatus 1 is powered on, the CPU 2 activates the host controller 3. Further, upon the power-on, the CPU 2 delivers an instruction to the host controller 3. This instruction is an activation instruction for starting a quick boot operation which is preset in the CPU 2, and this activation instruction is composed of, for example, an instruction code which is indicative of a quick boot, and data storage addresses. The activation instruction is delivered to the SD I/F 34 via the host I/F 31 and DMA controller 32 of the host controller 3. According to the activation instruction, the CMD generator 35 of the SD I/F 34 outputs a command CMD0 which instructs a data read operation, and the DAT generator 36 outputs a specific signal.

FIG. 3 shows the CMD0 and the specific signal, which are generated according to the activation instruction. Specifically, on the falling edge of the clock signal SDCLK, the CMD generator 35 generates a command CMD0 and delivers the command CMD0 to the command line. A start bit “S” and an end bit “E” are added before and after the command CMD0. The DAT generator 36 generates a specific signal which is set at a low level in accordance with a period of the command CMD0, and delivers this signal to a data line SDDAT0. Specifically, the specific signal of the data line SDDAT0 is set at a low level in accordance with the output of the command CMD0, and is restored to the high level at the same time as the end bit of the command CMD0. This becomes the quick boot request to the SD device 5.

Responding to the quick boot request, the controller 60 of the SD device 5 reads, for example, the boot code 1 from the boot code area 52 of the flash memory 50, and outputs the boot code 1 to the data line SDDAT 0-3 within one second. The read boot code 1 is transferred to the host controller 3 in a 4-bit mode in association with each data of, e.g. 512 bytes+CRC (cyclic redundancy check code).

The DMA controller 32 of the host controller 3 transfers the boot code 1, which has been transferred to the buffer 33 via the SD I/F 34, to the system memory 4 via the host I/F 31. In other words, the DMA controller 32 transfers the boot code 1 in the buffer 33 to the system memory 4 in accordance with the activation instruction which is delivered from the CPU 2. The CPU 2 executes the boot code 1 that has been transferred to the system memory 4, and activates the host apparatus.

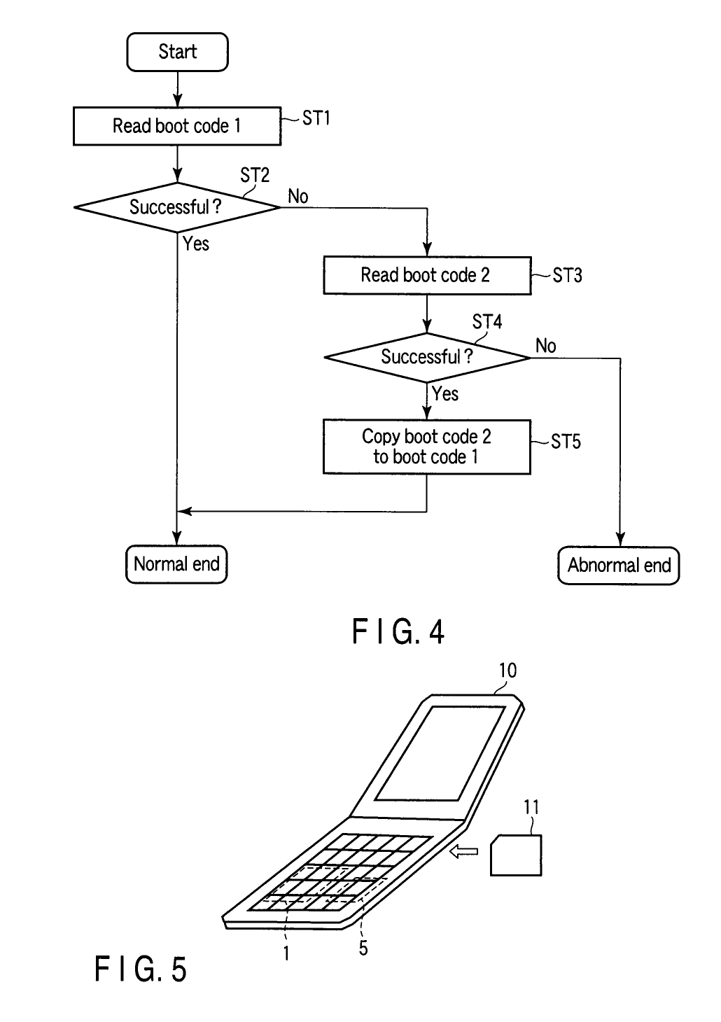

FIG. 4 is a flow chart illustrating an access method of the boot code area 52 by the controller 60.

As has been described above, the boot code area 52 stores the identical boot codes 1 and 2. Responding to the quick boot request, the controller 60 first reads the boot code 1 (ST1). It is then determined whether the read of the boot code 1 is successful or not (ST2). If the read of the boot code 1 is successful, the process is normally finished.

On the other hand, if the read of the boot code 1 has failed, the boot code 2 is read (ST3). It is then determined whether the read of the boot code 2 is successful or not (ST4). If the read of the boot code 2 is successful, the normal boot code 2 is copied to the memory area of the boot code 1. As a result, the boot code 1 is overwritten with the boot code 2. Thereby, the normal boot code is first accessed.

FIG. 5 shows an example of application of the present embodiment. FIG. 5 shows a mobile terminal apparatus 10 which is, for instance, a mobile phone. The mobile terminal apparatus 10 incorporates within the main body thereof the host apparatus 1 including the CPU 2, system memory 4 and host controller 3 according to the above-described embodiment. In addition, the electronic device 5 according to the embodiment is embedded in the mobile terminal apparatus 10. Furthermore, an electronic device 11 including a NAND flash memory is attachable to the mobile terminal apparatus 10.

The mobile terminal apparatus is not limited to the mobile phone, and may be a personal computer, a portable music recording/playback apparatus, etc.

According to the above-described embodiment, when power is turned on, the host controller 3 generates a command and a specific signal in accordance with an instruction from the CPU 2. The SD device 5 reads the boot code on the basis of the command and specific signal. Subsequently, the boot code is transferred to the system memory 4 by the DMA controller 32 of the host controller 3. Thus, unlike the prior art, a system ROM for storing a boot loader is needless. Therefore, the manufacturing cost of the host apparatus 1 can be reduced.

Furthermore, the SD device 5 stores the identical boot codes 1 and 2. If a defect occurs in the boot code 1, the boot code 2 can be read. Therefore, the boot operation can surely be executed, and the lifetime of the host apparatus 1 can be increased.

Besides, if a defect occurs in the boot code 1, the boot code 2 is copied to the memory area of the boot code 1. Thus, since the normal boot code is first accessed, the speed of the boot operation can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The present invention is used, for example, in a mobile terminal in which a flash memory is mounted.

What is claimed is:

1. An electronic device system comprising:
a first controller including a command terminal for outputting a command to an electronic device and a plurality of data terminals for transmitting/receiving data; and
an electronic device coupled to the first controller via the command terminal and the data terminals, the electronic device storing a boot information;
wherein when power is turned on, the first controller generates a signal and supplies the signal from one of the data terminals to the electronic device, and receives the boot information read from the electronic device in accordance with the signal.

2. The system according to claim 1, wherein the boot information includes a first boot code and a second boot code.

3. The system according to claim 2, wherein the second boot code is identical to the first boot code.

4. The system according to claim 3, wherein the first boot code is stored at a lower address than the second boot code.

5. The system according to claim 2, wherein the electronic device includes a second controller, the second controller being configured to read the first boot code in accordance with the signal.

6. The system according to claim 5, wherein the second controller is configured to read the second boot code in a case where the read of the first boot code has failed.

7. The system according to claim 6, wherein the second controller is configured to overwrite the first boot code with the second boot code in a case where the second boot code is read.

8. The system according to claim 1, wherein the first controller includes a direct memory access (DMA) controller configured to transfer the boot information, which has been read from the electronic device, to a system memory.

9. The system according to claim 1, wherein the boot information is received with use of the plurality of data terminals.

10. An electronic device comprising:
a memory configured to store boot information;
a command terminal configured to receive a command;
a plurality of data terminals configured to transmit/receive data; and
a controller configured to read the boot information from the memory, upon receiving a signal, which is delivered to one of the data terminals when power is turned on, the controller outputting the boot information from the data terminals.

11. The device according to claim 10, wherein the boot information includes a first boot code and a second boot code.

12. The device according to claim 11, wherein the second boot code is identical to the first boot code.

13. The device according to claim 12, wherein the first boot code is stored at a lower level address than the second boot code.

14. The device according to claim 13, wherein the controller is configured to read the first boot code in accordance with the signal.

15. The device according to claim 14, wherein the controller is configured to read the second boot code in a case where the read of the first boot code has failed.

16. The device according to claim 15, wherein the controller is configured to overwrite the first boot code with the second boot code in a case where the second boot code is read.

17. The device according to claim 10, wherein the boot information is output with use of the plurality of data terminals.

18. A mobile terminal comprising the electronic device system of claim 1.

19. A mobile terminal comprising the electronic device of claim 10.
